(19) United States
(12) Patent Application Publication
(10) Pub. No.: US 2010/0205940 A1
(43) Pub. Date: Aug. 19, 2010

(54) EXHAUST EMISSION CONTROL SYSTEM OF INTERNAL COMBUSTION ENGINE AND EXHAUST EMISSION CONTROL METHOD

(75) Inventors: Shunsuke Toshioka, Shizuoka-ken (JP); Tomihisa Oda, Shizuoka-ken (JP); Yutaka Tanai, Shizuoka-ken (JP); Shinya Asaura, Shizuoka-ken (JP); Yoshitaka Nakamura, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi, Aichi-ken (JP)

(21) Appl. No.: 12/675,947

(22) PCT Filed: Sep. 3, 2008
(86) PCT No.: PCT/IB2008/002640

§ 371 Date: Mar. 1, 2010

(30) Foreign Application Priority Data
Sep. 5, 2007 (JP) 2007-230669
Dec. 26, 2007 (JP) 2007-335191

(51) Int. Cl. F01N 11/00; F01N 3/10; F02D 45/00

(52) U.S. Cl. 60/276; 60/301; 60/286; 60/303

(57) ABSTRACT

In an exhaust emission control system of an internal combustion engine, a NOx selective reduction catalyst is disposed in an engine exhaust passage, and an aqueous solution of urea stored in an aqueous-urea tank is supplied to the NOx selective reduction catalyst so as to selectively reduce NOx. A NOx sensor is provided in the engine exhaust passage downstream of the NOx selective reduction catalyst for detecting the NOx conversion efficiency of the NOx selective reduction catalyst, and the concentration of aqueous urea in the aqueous-urea tank is estimated from the detected NOx conversion efficiency. The exhaust emission control system and method make it possible to detect the concentration of aqueous urea at reduced cost.

### BACKGROUND OF THE INVENTION

1. Field of the Invention

The invention relates to an exhaust emission control system of an internal combustion engine and its exhaust emission control method.

2. Description of the Related Art

In an exhaust emission control system of an internal combustion engine in which a NOx selective reduction catalyst is disposed in an engine exhaust passage, and an aqueous solution of urea stored in an aqueous-urea tank is supplied to the NOx selective reduction catalyst so that ammonia generated from aqueous urea selectively reduces NOx contained in exhaust gas, it is known in the art that an aqueous-urea concentration sensor is provided in the aqueous-urea tank for detecting an abnormality in the aqueous urea solution, as disclosed in, for example, Japanese Patent Application Publication No. 2005-83223 (JP-A-2005-83223).

However, the aqueous-urea concentration sensor is expensive, and the use of another inexpensive method for detecting an abnormality in aqueous urea has been desired.

### SUMMARY OF THE INVENTION

The present invention provides an exhaust emission control system capable of estimating the concentration of aqueous urea with reliability at reduced cost, and also provides such an exhaust emission control method

According to one aspect of the invention, in an exhaust emission control system of an internal combustion engine wherein a NOx selective reduction catalyst is disposed in an exhaust passage of the internal combustion engine, and aqueous urea stored in an aqueous-urea tank is supplied to the NOx selective reduction catalyst via an aqueous-urea supply valve, so that ammonia generated from the aqueous urea selectively reduces NOx contained in exhaust gas, a NOx sensor is disposed in the exhaust passage downstream of the NOx selective reduction catalyst so as to detect a NOx conversion efficiency of the NOx selective reduction catalyst, and the concentration of aqueous urea in the aqueous-urea tank is estimated from the detected NOx conversion efficiency.

According to another aspect of the invention, an exhaust emission control method of an internal combustion engine in which a NOx selective reduction catalyst is disposed in an exhaust passage of the engine, and a NOx sensor is disposed in the exhaust passage downstream of the NOx selective reduction catalyst so as to detect a NOx conversion efficiency of the NOx selective reduction catalyst is provided in which aqueous urea stored in an aqueous-urea tank is supplied to the NOx selective reduction catalyst via an aqueous-urea supply valve, so that ammonia generated from the aqueous urea selectively reduces NOx contained in exhaust gas. The exhaust emission control method includes the steps of: obtaining a relationship between the NOx conversion efficiency and the concentration of the aqueous urea, detecting the NOx conversion efficiency of the NOx selective reduction catalyst by means of the NOx sensor, and estimating the concentration of the aqueous urea in the aqueous-urea tank from the detected NOx conversion efficiency.

In the exhaust emission control system and exhaust emission control method of the internal combustion engine as described above, the relationship between the NOx conversion efficiency and the concentration of aqueous urea is obtained in advance, and the NOx conversion efficiency of the NOx selective reduction catalyst is detected, so that the concentration of aqueous urea in the aqueous-urea tank can be estimated from the detected NOx conversion efficiency. It is thus possible to estimate the concentration of aqueous urea without specially providing an aqueous-urea concentration sensor. Accordingly, the concentration of aqueous urea can be detected at reduced cost.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a general view of a compression ignition type internal combustion engine to which embodiments of the present invention are applied;

FIG. 2 is a view indicating the relationship between the NOx conversion efficiency and the concentration of aqueous urea;

FIG. 3 is a view showing a map used for determining the amount NOXA of NOx emitted from the engine;

FIG. 4 is a view showing the timing of generation of detection commands and detection execution commands;

FIG. 5 is a flowchart illustrating a control routine executed when a detection command is generated in a first embodiment of the invention;

FIG. 6 is a flowchart illustrating a control routine executed when a detection execution command is generated in the first embodiment of the invention;

FIG. 7A and FIG. 7B are time charts showing changes in the liquid level of aqueous urea in a second embodiment of the invention;

FIG. 8 is a flowchart illustrating a control routine for detecting supply of aqueous urea into an aqueous urea-tank for refilling in the second embodiment of the invention;

FIG. 9 is a flowchart illustrating a control routine executed when a detection execution command is generated in the second embodiment of the invention;

FIG. 10A and FIG. 10B are views showing changes in the liquid level of aqueous urea and the assumed concentration of aqueous urea in a third embodiment of the invention;

FIG. 11 is a flowchart illustrating a control routine for detecting supply of aqueous urea into an aqueous-urea tank in the third embodiment of the invention

FIG. 12 is a flowchart illustrating a control routine executed when a detection execution command is generated in the third embodiment of the invention;

FIG. 13A, FIG. 13B and FIG. 13C are views showing changes in the rates RA, RB, RC of reduction of the detected NOx conversion efficiency, respectively, in a fourth embodiment of the invention;

FIG. 14A is a view useful for explaining a first example of method of obtaining the reduction rate RA of the detected NOx conversion efficiency in the fourth embodiment of the invention;

FIG. 14B is a view useful for explaining a second example of method of obtaining the reduction rate RA of the detected NOx conversion efficiency in the fourth embodiment of the invention;

FIG. 15 is a view useful for explaining another example of method of obtaining the reduction rate RA of the detected NOx conversion efficiency in the fourth embodiment of the invention;

FIG. 16A and FIG. 16B are views useful for explaining an example of method of obtaining the reduction rate RB of the detected NOx conversion efficiency in the fourth embodiment of the invention;

FIG. 17A and FIG. 17B are views useful for explaining a first example of method of obtaining the reduction rate RC of the detected NOx conversion efficiency in the fourth embodiment of the invention;

FIG. 18 is a view useful for explaining a second example of method of obtaining the reduction rate RC of the detected NOx conversion efficiency in the fourth embodiment of the invention;

FIG. 19A and FIG. 19B are views useful for explaining a third example of method of obtaining the reduction rate RC of the detected NOx conversion efficiency in the fourth embodiment of the invention; and

FIG. 20 is a flowchart illustrating a control routine executed when a detection execution command is generated in the fourth embodiment of the invention.

### DETAILED DESCRIPTION OF THE EMBODIMENTS

Example embodiments of the present invention will be described in greater detail with reference to the accompanying drawings.

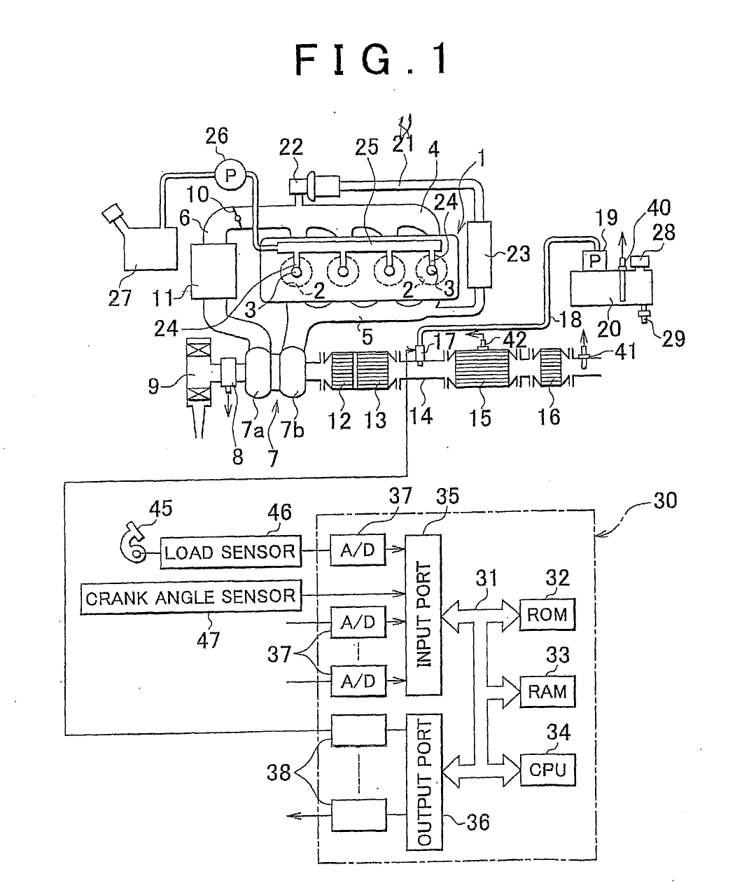

FIG. 1 is a general view of a compression ignition type internal combustion engine. The engine of FIG. 1 includes an engine body 1, combustion chambers 2 of respective cylinders, electronically controlled fuel injection valves 3 for injecting fuel into the respective combustion chambers 2, an intake manifold 4, and an exhaust manifold 5. The intake manifold 4 is connected to an outlet of a compressor 7a of an exhaust gas turbocharger 7 via an intake duct 6, and an inlet of the compressor 7a is connected to an air cleaner 9 via an air flow meter 8 for detecting the amount of intake air. A throttle valve 10 adapted to be driven by a stepping motor is disposed in the intake duct 6, and a cooling device 11 for cooling intake air flowing in the intake duct 6 is disposed around the intake duct 6. In the embodiment shown in FIG. 1, an engine coolant is fed to the cooling device 11, so that the intake air is cooled by the engine coolant.

On the other hand, the exhaust manifold 5 is connected to an inlet of an exhaust gas turbine 7b of the exhaust gas turbocharger 7, and an outlet of the exhaust gas turbine 7b is connected to an inlet of an oxidation catalyst 12. A particulate filter 13 for capturing particulate matter contained in exhaust gas is disposed downstream of the oxidation catalyst 12, at a location adjacent to the oxidation catalyst 12, and an outlet of the particulate filter 13 is connected to an inlet of a NOx selective reduction catalyst 15 via an exhaust pipe 14. An oxidation catalyst 16 is connected to an outlet of the NOx selective reduction catalyst 15.

An aqueous-urea supply valve 17 is disposed in the exhaust pipe 14 upstream of the NOx selective reduction catalyst 15, and the aqueous-urea supply valve 17 is connected to an aqueous-urea tank 20 via a supply pipe 18 and a supply pump 19. An aqueous solution of urea (which will also be called “aqueous urea”) stored in the aqueous-urea tank 20 is injected by the supply pump 19 from the aqueous-urea supply valve 17 into exhaust gas flowing in the exhaust pipe 14, and NOx contained in the exhaust gas is reduced by ammonia ((NH₂)2CO+H₂O→2NH₃+CO₂) generated from urea, at the NOx selective reduction catalyst 15.

The exhaust manifold 5 and the intake manifold 4 are connected to each other via an exhaust gas recirculation (which will be called “EGR”) passage 21, and an electronically controlled EGR control valve 22 is disposed in the EGR passage 21. Also, a cooling device 23 for cooling EGR gas flowing in the EGR passage 21 is disposed around the EGR passage 21. In the embodiment as shown in FIG. 1, the engine coolant is fed to the cooling device 23, so that the EGR gas is cooled by the engine coolant. In the meantime, the respective fuel injection valves 3 are connected to a common rail 25 via fuel supply pipes 24, and the common rail 25 is connected to a fuel tank 27 via an electronically controlled fuel pump 26 whose fuel delivery amount is variable. The fuel stored in the fuel tank 27 is supplied into the common rail 25 by the fuel pump 26, and the fuel supplied into the common rail 25 is supplied to the fuel injection valves 3 via the corresponding fuel supply pipes 24.

As shown in FIG. 1, the aqueous-urea tank 20 has a cap 28 attached to a filler port that receives aqueous urea for refilling of the tank 20, and a drain cock 29 through which aqueous urea remaining in the aqueous-urea tank 20 is discharged. In addition, a level sensor 40 capable of detecting the liquid level of the aqueous urea solution in the aqueous-urea tank 20 is disposed in the aqueous-urea tank 20. The level sensor 40 produces an output that is proportional to the liquid level of the aqueous urea solution in the aqueous-urea tank 20.

In the meantime, a NOx sensor 41 capable of detecting the NOx concentration in the exhaust gas is disposed in an engine exhaust passage downstream of the oxidation catalyst 16. The NOx sensor 41 produces an output that is proportional to the NOx concentration in the exhaust gas. Also, a temperature sensor 42 for detecting the temperature of the NOx selective reduction catalyst 15 is disposed in the NOx selective reduction catalyst 15.

An electronic control unit 30 consists of a digital computer, and includes ROM (read-only memory) 32, RAM (random access memory) 33, CPU (microprocessor) 34, input port 35 and output port 36, which are connected to each other via a bidirectional bus 31. The input port 35 receives output signals of the level sensor 40, NOx sensor 41, temperature sensor 42 and the air flow meter 8, via corresponding A/D converters 37. A load sensor 46 that produces an output voltage proportional to the amount L of depression of an accelerator pedal 45 is connected to the accelerator pedal 45, and the input port 35 receives the output voltage of the load sensor 46 via a corresponding A/D converter 37. In addition, a crank angle sensor 47 that produces an output pulse each time the crankshaft rotates, for example, 15° is connected to the input port 35. On the other hand, the output port 36 is connected to the fuel injection valves 3, stepping motor for driving the throttle valve 10, aqueous-urea supply valve 17, supply pump 19, EGR control valve 22 and the fuel pump 26, via corresponding drive circuits 38.

The oxidation catalyst 12 is loaded with a noble metal catalyst, such as platinum, and has the function of converting NO contained in the exhaust gas into NO₂ and the function of oxidizing HC contained in the exhaust gas. Namely, the conversion of NO into NO₂ having a higher oxidizing capability than NO leads to promotion of oxidation of the particulate matter captured by the particulate filter, and promotion of reduction of NOx by ammonia at the NOx selective reduction catalyst. The particulate filter 13 may not be loaded with a catalyst, or may be loaded with a noble metal catalyst, such as platinum. The NOx selective reduction catalyst 15 may be formed of Fe zeolite capable of adsorbing ammonia, which has a high NOx conversion efficiency at low temperatures, or may be formed of titanium-vanadium based catalyst having no capability of adsorbing ammonia. The oxidation catalyst 16 is loaded with a noble metal catalyst, such as platinum, and has the function of oxidizing ammonia leaking or slipping out of the NOx selective reduction catalyst 15.

In the internal combustion engine constructed as described above, the nominal aqueous solution of urea to be used is predetermined, namely, the concentration of urea in the nominal aqueous urea solution is set to a constant value, for example, 32.5%. On the other hand, once the operating conditions of the engine are determined, the amount of NOx emitted from the engine is determined, and the amount of aqueous urea required for reducing NOx emitted from the engine is supplied from the aqueous-urea supply valve 17 into the exhaust pipe 14. Namely, the aqueous urea solution is supplied in an amount having an equivalence ratio of 1 with respect to the amount of NOx emitted from the engine. Where the nominal aqueous urea solution is used, and the aqueous urea solution is supplied in an amount having an equivalence ratio of 1 with respect to the NOx amount, the NOx conversion efficiency of the NOx selective reduction catalyst 15 becomes equal to a constant value, e.g., 90%, as long as the NOx selective reduction catalyst 15 is not deteriorated.

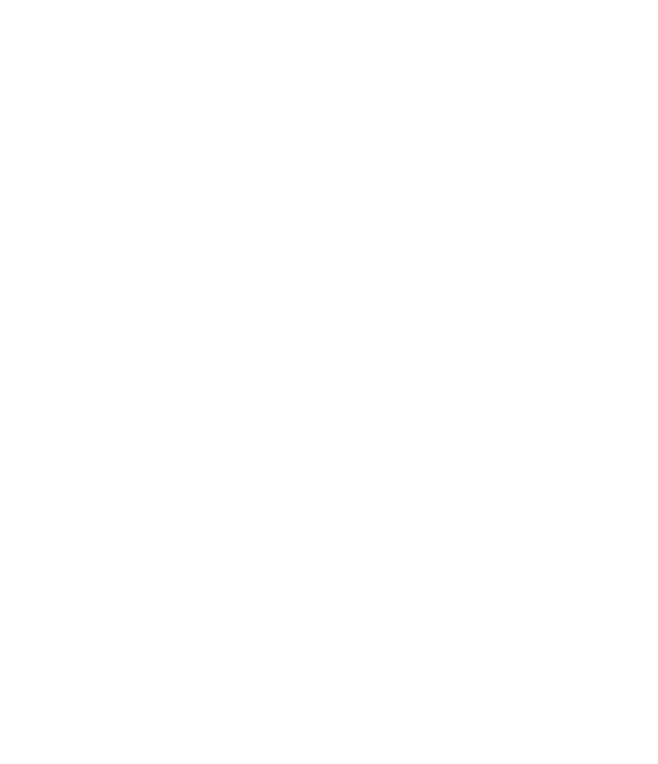

If, on the other hand, the nominal aqueous urea solution is not used, but an aqueous urea solution having a lower concentration than the nominal aqueous urea solution is used, and is supplied in the same amount as that of the case where the nominal aqueous urea solution is used, the NOx conversion efficiency of the NOx selective reduction catalyst 15 is reduced. In this case, the NOx conversion efficiency of the NOx selective reduction catalyst 15 is directly proportional to the concentration of aqueous urea used, as shown in FIG. 2. The relationship between the NOx conversion efficiency and the aqueous urea concentration is obtained in advance through an experiment, or the like.

Once the operating conditions of the engine are determined, the amount of NOx emitted from the engine, more precisely, the amount of NOx emitted per unit time from engine, is determined, as described above, and the amount of NOx that enters the NOx selective reduction catalyst 15 per unit time is determined. On the other hand, the result of multiplication obtained by multiplying the NOx concentration detected by the NOx sensor 41 by the amount of exhaust gas emitted per unit time, i.e., the amount of intake air per unit time, represents the amount of NOx emitted per unit time from the NOx selective reduction catalyst 15 without being converted. It follows that the NOx conversion efficiency of the NOx selective reduction catalyst 15 can be detected or determined by the NOx sensor 41.

As described above, the NOx conversion efficiency of the NOx selective reduction catalyst 15 is directly proportional the concentration of aqueous urea used, as shown in FIG. 2. On the other hand, the NOx conversion efficiency of the NOx selective reduction catalyst 15 can be detected by the NOx sensor 41. Accordingly, the concentration of aqueous urea in the aqueous-urea tank 20 can be estimated from the NOx conversion efficiency detected by the NOx sensor 41.

Next, one embodiment of the present invention for estimating the concentration of aqueous urea in the aqueous-urea tank 20 will be described. In this embodiment, the amount NOXA of NOx emitted per unit time from the engine is stored in advance, in the ROM 32, in the form of a map as shown in FIG. 3, as a function of the engine output torque TQ and the engine speed N, and the amount NOXA of NOx entering the NOx selective reduction catalyst 15 per unit time is calculated from the map of FIG. 3.

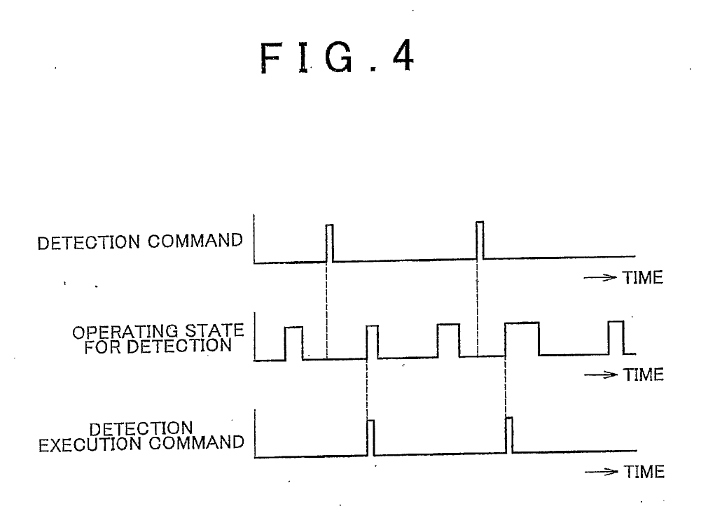

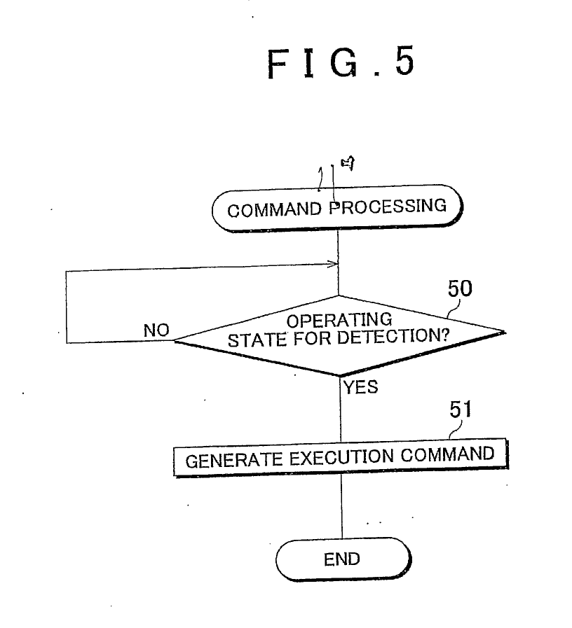

In this embodiment of the invention, detection commands for detecting the NOx conversion efficiency are intermittently generated as shown in FIG. 4. The detection command may be generated at given time intervals during engine operation, or may be generated only once during a period from the time at which the engine starts operating to the time at which the engine stops operating. If the detection command is generated, a command processing routine as shown in FIG. 5 is executed.

Upon execution of the command processing routine, it is determined in step 50 whether the current operating state of the engine is a predetermined operating state suitable for detection of the NOx conversion efficiency. The operating state suitable for detection is an engine operating state in which the amount of NOx emitted from the engine has stabilized, and the NOx conversion efficiency of the NOx selective reduction catalyst 15 has stabilized. The operating state suitable for detection is predetermined based on the output torque of the engine, the engine speed, the temperature of the NOx selective reduction catalyst 15, and so forth. If it is determined in step 50 that the engine operating state is the operating state suitable for detection, the control proceeds to step 51 to generate a detection execution command. Namely, when the engine is brought into the operating state suitable for detection for the first time after generation of the detection command, the detection execution command is generated.

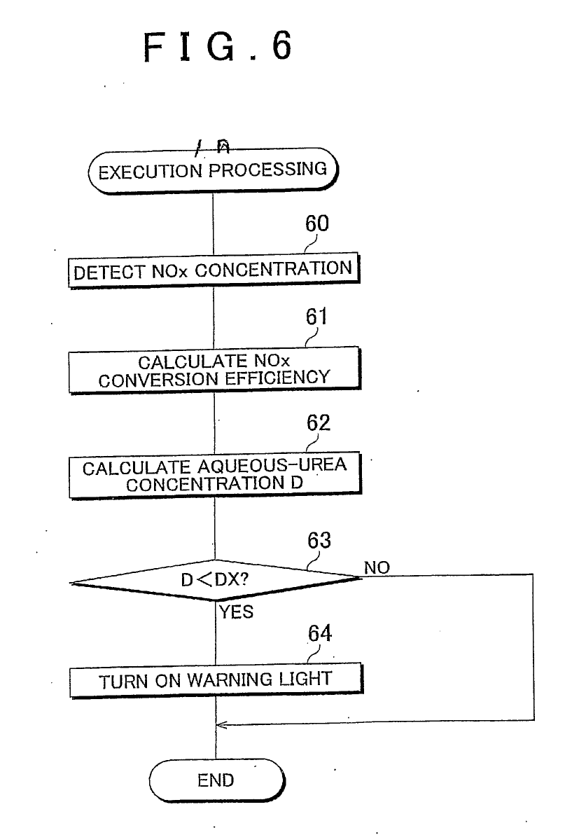

Upon generation of the detection execution command, a detection execution routine as shown in FIG. 6 is executed. Initially, the NOx concentration in the exhaust gas is detected by the NOx sensor 41 in step 60. In step 61, the NOx conversion efficiency of the NOx selective reduction catalyst 15 is calculated based on the amount of NOx entering the NOx selective reduction catalyst 15, which is calculated from the map of FIG. 3, and the amount of NOx flowing out of the NOx selective reduction catalyst 15, which is calculated from the NOx concentration detected by the NOx sensor 41 and the intake air amount.

Subsequently, in step 62, the concentration D of aqueous urea is calculated from the NOx conversion efficiency obtained in step 61, based on the relationship as shown in FIG. 2. In this embodiment, the concentration of aqueous urea is estimated in this manner.

If an aqueous urea solution having a lower concentration than that of the nominal aqueous urea solution is improperly used as aqueous urea, or a liquid, such as water, other than the aqueous urea solution, is improperly used, the NOx conversion efficiency of the NOx selective reduction catalyst 15 is extremely reduced, resulting in a major problem. Thus, in this embodiment of the invention, when the NOx conversion efficiency detected by the NOx sensor 41 is reduced, this is regarded as representing an abnormal condition in which the concentration of aqueous urea in the aqueous-urea tank 20 is abnormally reduced, and an alarm is generated.

More specifically described with reference to the flowchart of FIG. 6, it is determined in step 63 whether the concentration D of aqueous urea is lower than a predetermined threshold concentration DX, and, if the concentration D of aqueous urea is lower than the threshold concentration DX, the control proceeds to step 64 to turn on the warning light.

As described above, the concentration of aqueous urea in the aqueous-urea tank 20 is presumed to be reduced when the NOx conversion efficiency of the NOx selective reduction catalyst 15 is reduced. However, the NOx conversion efficiency of the NOx selective reduction catalyst 15 is also reduced when the NOx selective reduction catalyst 15 deteriorates, or when a failure, such as clogging, occurs in the aqueous-urea supply valve 17.

When the NOx conversion efficiency of the NOx selective reduction catalyst 15 is reduced after the aqueous-urea tank 20 is refilled with aqueous urea (i.e., aqueous urea is added or supplied into the aqueous-urea tank 20), there is an extremely high possibility of wrong use of an aqueous urea solution having a lower concentration than that of the nominal aqueous urea solution, as the aqueous urea added, or wrong use of a liquid other than aqueous urea. In this case, therefore, a reduction in the NOx conversion efficiency of the NOx selective reduction catalyst 15 may be presumed to be caused by a reduction in the concentration of aqueous urea in the aqueous-urea tank 20.

Thus, in a second embodiment of the present invention as described below, it is determined by use of the level sensor 40 whether a supplementary liquid has been supplied into the aqueous-urea tank 20 for refilling. If it is determined that the supplementary liquid has been supplied into the aqueous-urea tank 20, and the NOx conversion efficiency detected after the supply of the supplementary liquid becomes lower than a predetermined permissible level, the concentration of aqueous urea in the aqueous-urea tank 20 is estimated from the detected NOx conversion efficiency.

In the second embodiment of the invention, if it is determined that the supplementary liquid has been supplied to the aqueous-urea tank 20, and the NOx conversion efficiency detected after the supply of the supplementary liquid is lower than the predetermined permissible level, an abnormal condition in which the concentration of aqueous urea in the aqueous-urea tank 20 is abnormally reduced is presumed to be established.

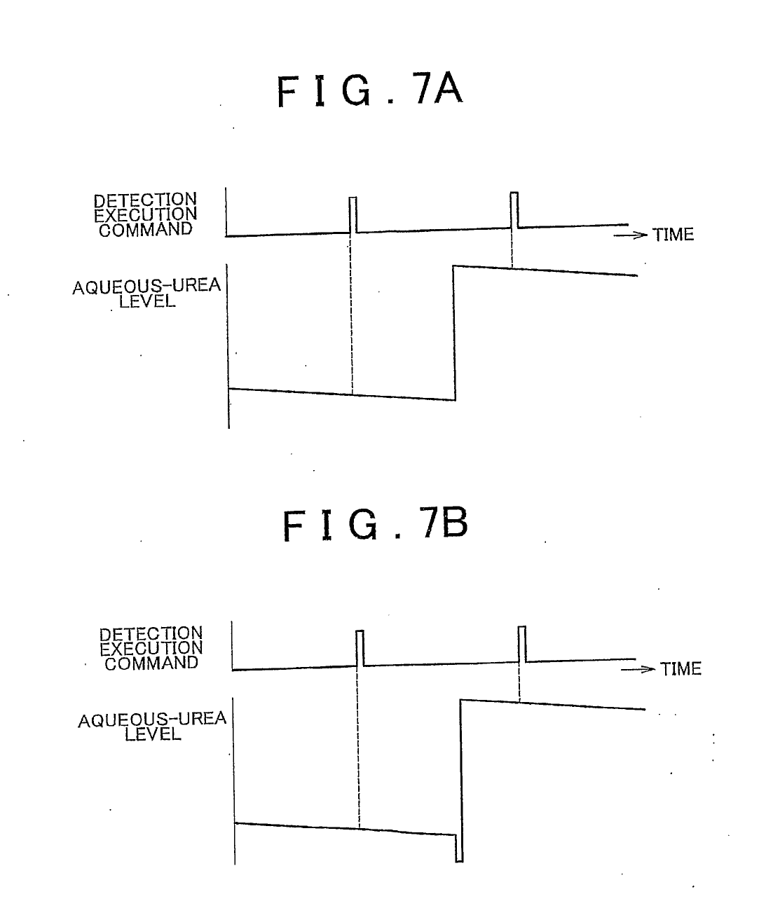

FIG. 7A and FIG. 7B show the timing of generation of the detection execution commands and changes in the liquid level of aqueous urea in the aqueous-urea tank 20, for explanation of the second embodiment. FIG. 7A shows the case where the supplementary liquid is added or supplied into the aqueous-urea tank 20 at a point in time between two detection execution commands, and FIG. 7B shows the case where the supplementary liquid is added or supplied into the aqueous-urea tank 20 after aqueous urea remaining in the aqueous-urea tank 20 is discharged to the outside through the drain cock 29, at a point in time between two detection execution commands.

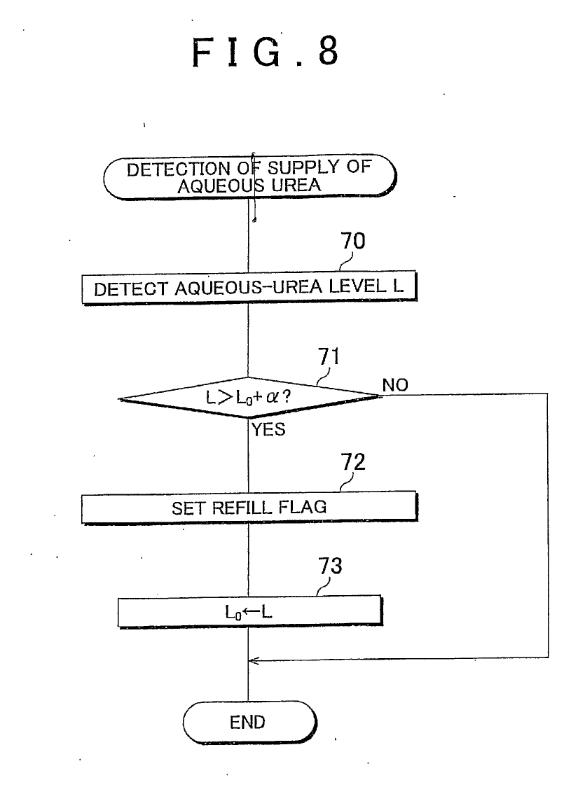

FIG. 8 illustrates a detection routine for detecting supply of aqueous urea into the aqueous-urea tank 20 for refilling. The routine of FIG. 8, which is an interrupt routine, is executed at short time intervals.

Referring to FIG. 8, the routine starts with step 70 in which the liquid level L of aqueous urea in the aqueous-urea tank 20 is detected by the level sensor 40. Then, it is determined in step 71 whether the detected aqueous-urea level L is higher by a given value a or greater than the aqueous-urea level L₀ detected in the last cycle of the interrupt routine. If L is higher than (L₀+α) (L>L₀+α), it is determined that the supplementary liquid has been added or supplied into the aqueous-urea tank 20, and a refill flag that indicates that a refilling operation has been performed is set in step 72. Then, the aqueous-urea level L detected in this cycle is set as L₀ in step 73.

In step 71 of FIG. 8, it is determined whether the amount (L−L₀) of addition of the supplementary liquid (i.e., the difference in the liquid level of aqueous urea) is greater than the given value α. In the case of FIG. 7A, the amount (L−L₀) is correctly detected irrespective of whether the detection routine as shown in FIG. 8 stops being executed or is kept executed during the refilling operation. In the case of FIG. 7B, on the other hand, the detection routine as shown in FIG. 8 needs to be kept executed during discharge of the remaining aqueous urea and refilling, so as to correctly detect the amount (L−L₀).

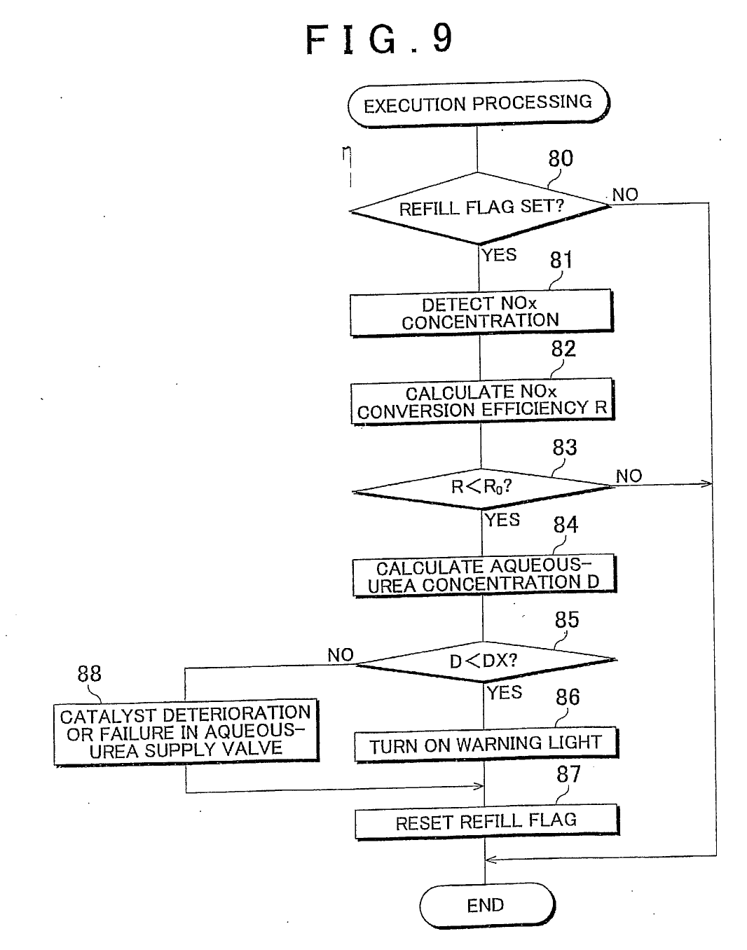

When the detection execution command as shown in FIG. 7A or FIG. 7B is generated, a detection execution routine as shown in FIG. 9 is executed. Initially, it is determined in step 80 whether the refill flag is set. If the refill flag is not set, the current cycle of this routine ends. On the other hand, if the refill flag is set, namely, if the supplementary liquid has been added or supplied into the aqueous-urea tank 20, the control proceeds to step 81.

In step 81, the NOx concentration in the exhaust gas is detected by the NOx sensor 41. Then, in step 82, the NOx conversion efficiency R of the NOx selective reduction catalyst 15 is calculated using the amount of NOx entering the NOx selective reduction catalyst 15, which is calculated from the map shown in FIG. 3, and the amount of NOx flowing out of the NOx selective reduction catalyst 15, which is calculated from the NOx concentration detected by the NOx sensor 41 and the intake air amount.

Subsequently, it is determined in step 83 whether the NOx conversion efficiency R is lower than a predetermined permissible level R₀. If the NOx conversion efficiency R is lower than the permissible level R₀, it is presumed that the concentration of aqueous urea in the aqueous-urea tank 20 has been reduced due to the supply of the supplementary liquid into the aqueous-urea tank 20, and the concentration D of aqueous urea is calculated from the NOx conversion efficiency R, based on the relationship shown in FIG. 2. Then, it is determined in step 85 whether the concentration D of aqueous urea in the aqueous-urea tank 20 is lower than a predetermined threshold concentration DX. If the concentration D of aqueous urea is lower than the threshold concentration DX, the control proceeds to step 86 to turn on the warning light that indicate an abnormality of the aqueous urea solution in the aqueous-urea tank 20. Then, the refill flag is reset in step 87.

If it is determined in step S85 that D DX (i.e., the concentration of aqueous urea is equal to or higher, than the threshold concentration DX), on the other hand, the control proceeds to step 88 to determine that the NOx selective reduction catalyst 15 has deteriorated, or a failure occurs in the aqueous-urea supply valve 17, or the like. As is understood from FIG. 9, the determination as to whether the NOx conversion efficiency R has been reduced is made only when the refill flag is set, and the refill set is reset after this determination is done. It will be thus understood that the determination as to whether the NOx conversion efficiency R has been reduced is made only once when a detection execution command is generated for the first time after supply of the supplementary liquid (refilling of the aqueous-urea tank 20).

Next, a third embodiment of the invention will be described. While the concentration of aqueous urea is presumed to be reduced when the NOx conversion efficiency is reduced, as described above, the concentration of aqueous urea may be erroneously recognized as being reduced even though the concentration of aqueous urea is not actually reduced. In the third embodiment, such an erroneous recognition or presumption is prevented.

In the third embodiment, assuming that the supplementary liquid added or supplied into the aqueous-urea tank 20 is a liquid whose ammonia concentration is equal to zero, the concentration of aqueous urea in the aqueous-urea tank 20 after the supply of the supplementary liquid is calculated based on the above assumption. The assumed concentration of aqueous urea is used for preventing the concentration of aqueous urea from being erroneously recognized as being reduced even though the concentration of aqueous urea is not actually reduced.

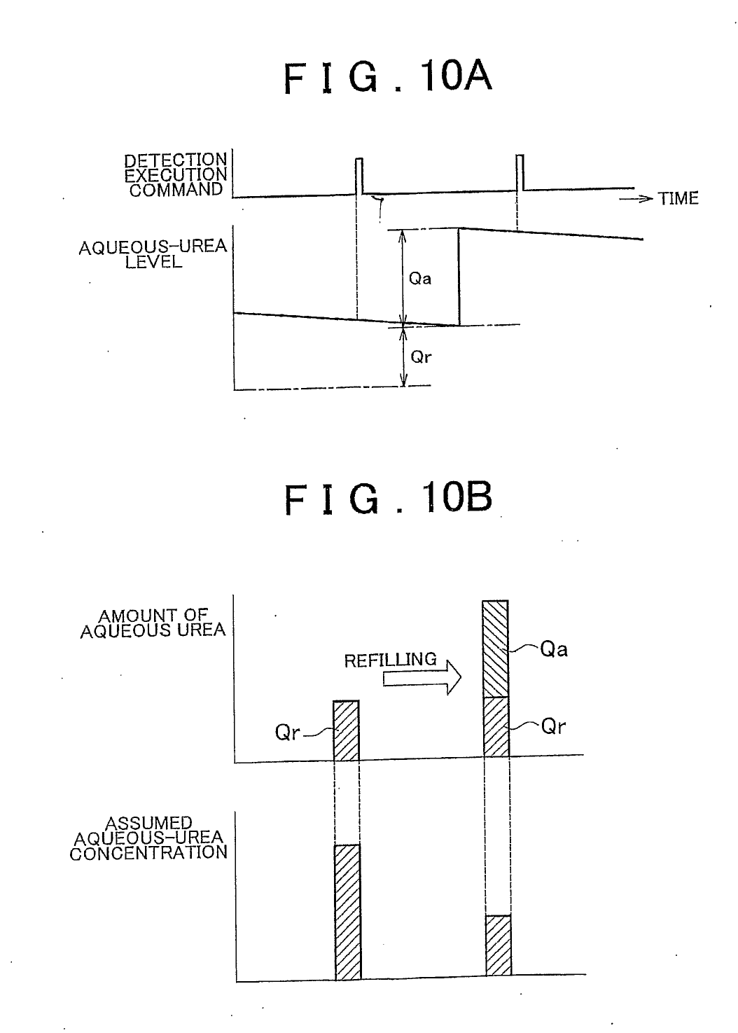

Supposing a Qa amount of supplementary liquid is supplied into the aqueous-urea tank 20 when a Qr amount of aqueous urea remains in the tank 20, as shown in FIG. 10A, the amount of aqueous urea in the aqueous-urea tank 20 increases from Qr to (Qr+Qa), as shown in FIG. 10B. Assuming that a supplementary liquid whose ammonia concentration is equal to zero is used as the supplementary liquid supplied to the aqueous-urea tank 20, which is a worst-case scenario, the concentration of aqueous urea'in the aqueous-urea tank 20 is reduced from the nominal concentration Db down to an assumed aqueous-urea concentration as represented by Db×Qr/(Qr+Qa). This assumed aqueous-urea concentration De (=Db×Qr/(Qr+Qa)) decreases as the amount Qa of the added supplementary liquid relative to the remaining amount Qr increases.

If the NOx conversion efficiency of the NOx selective reduction catalyst 15 is reduced to be lower than the permissible level when the amount Qa of supply of the supplementary liquid is small relative to the remaining amount Qr, namely, when the assumed aqueous-urea concentration is not so reduced, it is difficult to say that the NOx conversion efficiency is reduced due to the reduction of the concentration of aqueous urea in the aqueous-urea tank 20. On the other hand, if the NOx conversion efficiency is reduced to be lower than the permissible level when the supply amount Qr is large relative to the remaining amount Qr, there is an extremely high possibility that the NOx conversion efficiency is reduced due to the reduction of the concentration of aqueous urea in the aqueous-urea tank 20.

Thus, in the third embodiment, it is determined by the level sensor 40 whether the supplementary liquid has been supplied into the aqueous-urea tank 20, and the assumed concentration of aqueous urea in the aqueous-urea tank 20 after supply of the supplementary liquid is calculated assuming that the ammonia concentration in the supplementary liquid is equal to zero. If it is determined that the supplementary liquid has been supplied into the aqueous-urea tank 20, and the NOx conversion efficiency detected after the supply of the supplementary liquid is lower than the predetermined permissible level while the assumed concentration of aqueous urea is lower than a predetermined permissible concentration, an abnormal condition in which the concentration of aqueous urea in the aqueous-urea tank is abnormally reduced is presumed to be established.

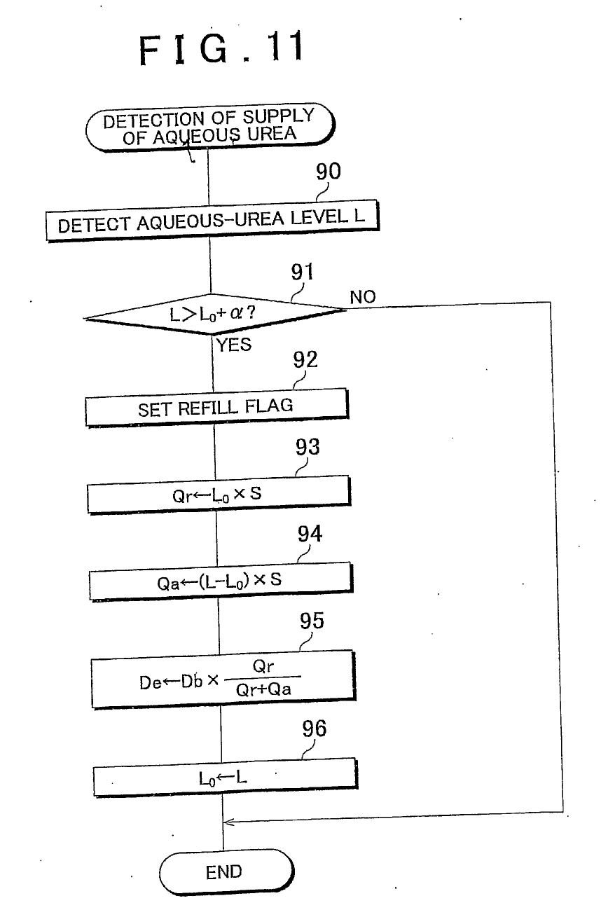

FIG. 11 illustrates a detection routine for detecting supply of aqueous urea into the aqueous-urea tank 20 (i.e., refilling of the aqueous-urea tank 20 with aqueous urea). The routine of FIG. 11, which is an interrupt routine, is executed at short time intervals.

Referring to FIG. 11, the routine starts with step 90 in which the liquid level L of the aqueous urea solution in the aqueous-urea tank 20 is detected by the level sensor 40. Then, it is determined in step 91 whether the detected aqueous-urea level L is higher by a given value a or greater than the aqueous-urea level L₀ detected during the last cycle of the interrupt routine. If L>L₀+α, it is determined that the supplementary liquid has been added or supplied into the aqueous-urea tank 20, and a refill flag that indicates that a refilling operation has been performed is set in step 92.

Subsequently, in step 93, the remaining amount Qr (=L₀×S) is calculated by multiplying the aqueous-urea level L₀ detected in the last cycle of the interrupt routine by the cross-sectional area S of the aqueous-urea tank 20. Then, in step 94, the amount Qa (=(L−L₀)×S) of the supplementary liquid added to the tank 20 is calculated by multiplying the amount of increase (L−L₀) of the aqueous-urea level by the cross-sectional area S of the aqueous-urea tank 20. Then, the assumed aqueous-urea concentration De (=Db×Qr/(Qr+Qa)) is calculated in step 95. Then, the aqueous-urea level L (i.e., the liquid level of aqueous urea in the aqueous-urea tank 20) is set as Lo in step 96.

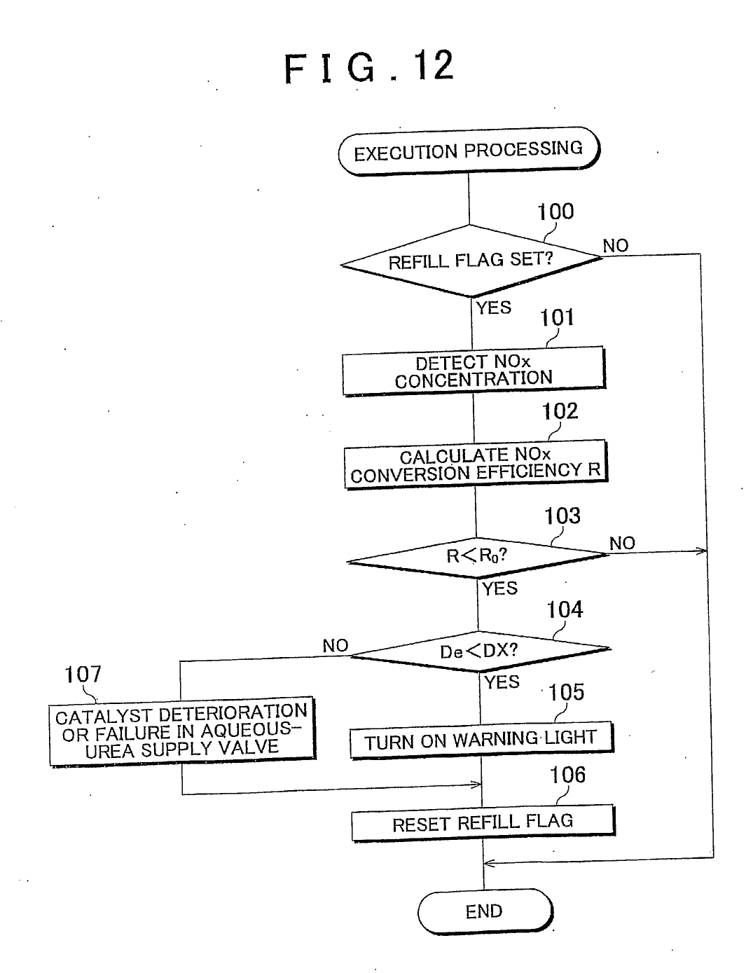

If a detection execution command as shown in FIG. 10A is generated, a detection execution routine as shown in FIG. 12 is executed. Initially, it is determined in step 100 whether the refill flag is set. If the refill flag is not set, the current cycle of the routine of FIG. 12 ends. On the other hand, if the refill flag is set, namely, if the supplementary liquid has been supplied into the aqueous-urea tank 20, the control proceeds to step 101.

In step 101, the NOx concentration in the exhaust gas is detected by the NOx sensor 41. Then, the NOx conversion efficiency R of the NOx selective reduction catalyst 15 is calculated in step 102, using the amount of NOx entering the NOx selective reduction catalyst 15, which is calculated from the map shown in FIG. 3, and the amount of NOx flowing out of the NOx selective reduction catalyst 15, which is calculated from the NOx concentration detected by the NOx sensor 41 and the intake air amount.

Subsequently, it is determined in step 103 whether the NOx conversion efficiency R is lower than a predetermined permissible level R₀. If the NOx conversion efficiency R is lower than the permissible level R₀, it is then determined in step 104 whether the assumed aqueous-urea concentration De is lower than a predetermined permissible concentration DX. If the assumed aqueous-urea concentration De is lower than the permissible concentration DX, the control proceeds to step 105 to turn on the warning lamp that indicates an abnormality of aqueous urea in the aqueous-urea tank 20, and then proceeds to step 106 to reset the refill flag.

If, on the other hand, it is determined in step 104 that De≧DX (i.e., the assumed aqueous-urea concentration is equal to or higher than the permissible concentration DX), it is determined in step 107 that the NOx selective reduction catalyst 15 has deteriorated, or a failure occurs in the aqueous-urea supply valve 17, or the like. In the third embodiment, too, the determination as to whether the NOx conversion efficiency R has been reduced is made only when the refill flag is set, and the refill flag is reset after this determination is done, as is understood from FIG. 12. Thus, in the third embodiment, too, the determination as to whether the NOx conversion efficiency has been reduced is made only once when a detection execution command is generated for the first time after supply of the supplementary liquid into the aqueous-urea tank 20.

The NOx conversion efficiency detected by the NOx sensor 41 decreases as the concentration of aqueous urea in the aqueous-urea tank 20 decreases. It is, however, to be noted that the NOx conversion efficiency detected by the NOx sensor 41 is also reduced in the case where the NOx sensor 41 deteriorates, or in the case where the NOx selective reduction catalyst 15 deteriorates, or in the case where a defect, such as clogging, occurs in the aqueous-urea supply valve 17. Accordingly, in order to determine a reduction in the concentration of aqueous urea in the aqueous-urea tank 20 from a reduction in the NOx conversion efficiency detected by the NOx sensor 41, it is necessary to eliminate influences of deterioration of the NOx sensor 41, deterioration of the NOx selective reduction catalyst 15 and the defect of the aqueous-urea supply valve 17, on the NOx conversion efficiency detected by the NOx sensor 41.

In a fourth embodiment of the invention, therefore, a NOx conversion efficiency used for estimating the aqueous-urea concentration, which does not involve a reduction in the detected NOx conversion efficiency due to deterioration of the NOx sensor 41, is obtained from the detected NOx conversion efficiency detected by the NOx sensor 41, and a NOx conversion efficiency used for estimating the aqueous-urea concentration, which does not involve a reduction in the detected NOx conversion efficiency due to deterioration of the NOx selective reduction catalyst 15, is obtained from the detected NOx conversion efficiency detected by the NOx sensor 41, while a NOx conversion efficiency used for estimating the aqueous-urea concentration, which does not involve a reduction in the NOx conversion efficiency due to the defect of the aqueous-urea supply valve 17, is obtained from the detected NOx conversion efficiency detected by the NOx sensor 41. Then, the concentration of aqueous urea in the aqueous-urea tank 20 is estimated from these NOx conversion efficiencies used for estimating the aqueous-urea concentration.

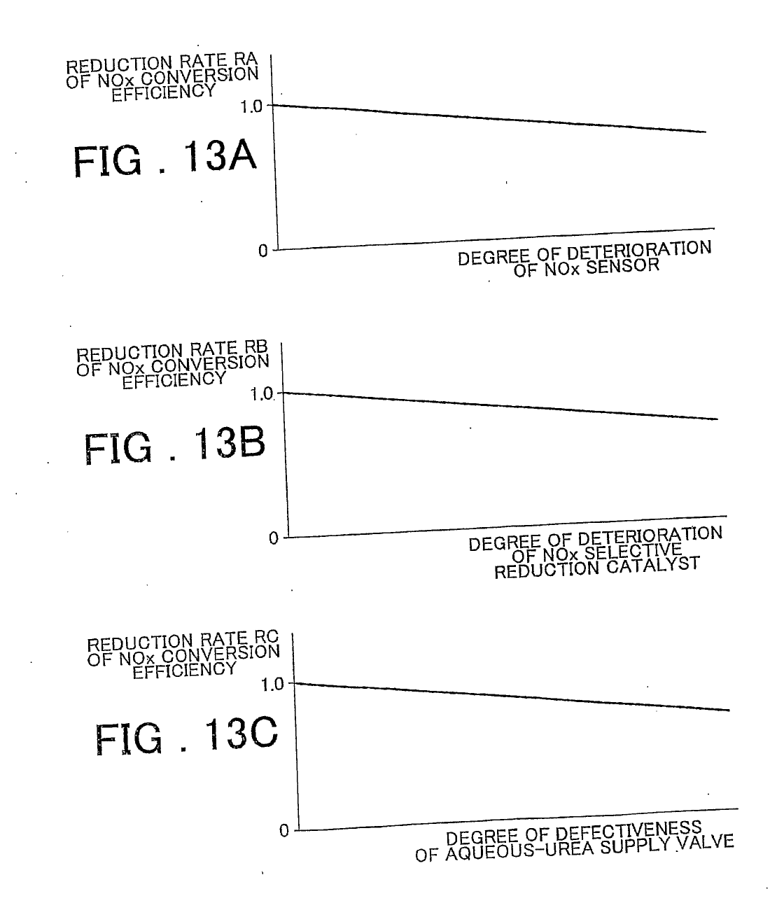

More specifically, the detected NOx conversion efficiency detected by the NOx sensor 41 decreases as the degree of deterioration of the NOx sensor 41 increases. Accordingly, the rate of reduction RA of the detected NOx conversion efficiency detected by the NOx sensor 41 gradually decreases with increase in the degree of deterioration of the NOx sensor 41, as shown in FIG. 13A. Specific methods of obtaining the rate of reduction RA of the NOx conversion efficiency will be explained later.

In this embodiment of the invention, the reduction rate RA of the detected NOx conversion efficiency due to deterioration of the NOx sensor 41 is obtained based on the degree of deterioration of the NOx sensor 41, and the NOx conversion efficiency used for estimating the aqueous-urea concentration when the NOx sensor 41 is not deteriorated is obtained from the detected NOx conversion efficiency detected by the NOx sensor 41 and the reduction rate RA of the NOx conversion efficiency. Namely, the NOx conversion efficiency used for estimating the aqueous-urea concentration is obtained by dividing the detected NOx conversion efficiency detected by the NOx sensor 41 by the reduction rate RA of the NOx conversion efficiency. Then, the concentration of aqueous urea in the aqueous-urea tank 20 is estimated from the thus obtained NOx conversion efficiency used for estimating the aqueous-urea concentration.

Also, the detected NOx conversion efficiency detected by the NOx sensor 41 decreases as the degree of deterioration of the NOx selective reduction catalyst 15 increases. Accordingly, the rate of reduction RB of the detected NOx conversion efficiency detected by the NOx sensor 41 gradually decreases with increase in the degree of deterioration of the NOx selective reduction catalyst 15, as shown in FIG. 13B. A specific method of obtaining the reduction rate RB of the NOx conversion efficiency will be also explained later.

In this embodiment of the invention, the reduction rate RB of the NOx conversion efficiency due to deterioration of the NOx selective reduction catalyst 15 is obtained based on the degree of deterioration of the NOx selective reduction catalyst 15, and the NOx conversion efficiency used for estimating the aqueous-urea concentration when the NOx selective reduction catalyst 15 is not deteriorated is obtained from the detected NOx conversion efficiency detected by the NOx sensor 41 and the reduction rate RB of the NOx conversion efficiency. Namely, the NOx conversion efficiency used for estimating the aqueous-urea concentration is obtained by dividing the detected NOx conversion efficiency detected by the NOx sensor 41 by the reduction rate RB of the NOx conversion efficiency. Then, the concentration of aqueous urea in the aqueous-urea tank 20 is estimated from the thus obtained NOx conversion efficiency used for estimating the aqueous-urea concentration.

Also, the detected NOx conversion efficiency detected by the NOx sensor 41 decreases as the degree of defectiveness in the aqueous-urea supply valve 17 increases. Accordingly, the rate of reduction RC of the detected NOx conversion efficiency detected by the NOx sensor 41 gradually decreases with increase in the degree of defectiveness in the aqueous-urea supply valve 17, as shown in FIG. 13C. Specific methods of obtaining the reduction rate RC of the NOx conversion efficiency will be also explained later.

In this embodiment of the invention, the reduction rate RC of the NOx conversion efficiency due to the defect of the aqueous-urea supply valve 17 is obtained based on the degree of defectiveness in the aqueous-urea supply valve 17, and the NOx conversion efficiency used for estimating the aqueous-urea concentration when the aqueous-urea supply valve 17 is in normal conditions is obtained from the detected NOx conversion efficiency detected by the NOx sensor 41 and the reduction rate RC of the NOx conversion efficiency. Namely, the NOx conversion efficiency used for estimating the aqueous-urea concentration is obtained by dividing the detected NOx conversion efficiency detected by the NOx sensor 41 by the reduction rate RC of the NOx conversion efficiency. Then, the concentration of aqueous urea in the aqueous-urea tank is estimated from the NOx conversion efficiency used for estimating the aqueous-urea concentration.

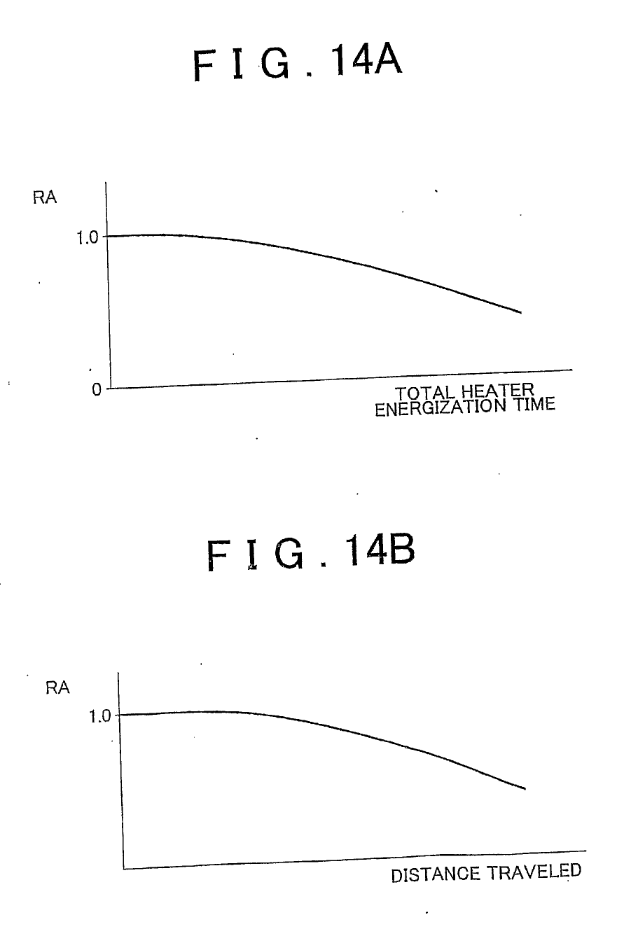

Next, the specific methods of obtaining the respective reduction rates RA, RB, RC of the detected NOx conversion efficiency will be explained in this order. Initially, the reduction rate RA of the detected NOx conversion efficiency will be explained. The NOx sensor 41 deteriorates as the energization time of a heater incorporated in the NOx sensor 41 for heating the NOx sensor increases, namely, as the length of time for which current is applied to the heater of the NOx sensor 41 increases. Accordingly, the detected NOx conversion efficiency is reduced with increase in the total energization time of the heater for heating the NOx sensor. The relationship between the total heater energization time and the reduction rate RA of the detected NOx conversion efficiency is empirically obtained in advance, as shown in FIG. 14A. In a first example, therefore, the reduction rate RA of the detected NOx conversion efficiency is obtained from the relationship as shown in FIG. 14A.

In a second example, the reduction rate RA of the detected NOx conversion efficiency is empirically obtained in advance as a function of the distance traveled by the vehicle, and the reduction rate RA of the detected NOx conversion efficiency is obtained from the relationship as shown in FIG. 14B. In another example, a model is provided for estimating the amount of NOx emitted from the engine, and the degree of deterioration of the NOx sensor 41 is determined by comparing the NOx amount calculated from the model and the output of the NOx sensor 41. In this case, the reduction rate RA of the detected NOx conversion efficiency is obtained from the thus determined degree of deterioration, based on the relationship as shown in FIG. 13A.

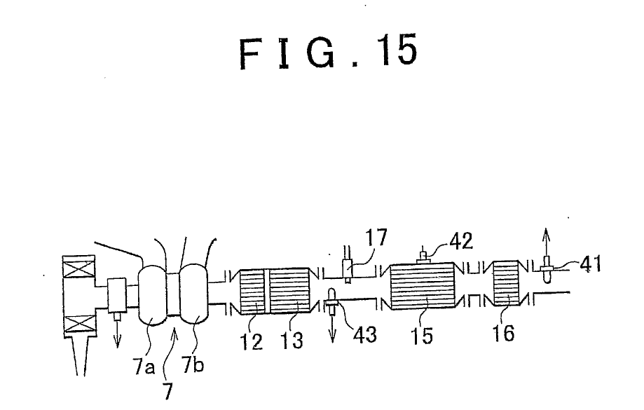

In a further example, another NOx sensor 43 is disposed upstream of the NOx selective reduction catalyst 15, as shown in FIG. 15, and the degree of deterioration of the NOx sensor 41 is determined by comparing the outputs of the NOx sensors 41, 43 with each other when the NOx selective reduction catalyst 15 is not in NOx converting operation, such as when the temperature of the NOx selective reduction catalyst 15 is low. With two NOx sensors 41, 43 thus provided, one of the NOx sensors is considered as operating normally, and it is determined that the NOx sensor 41 is deteriorated if the output of the NOx sensor 41 is lower than the output of the NOx sensor 43. In this case, the reduction rate RA of the detected NOx conversion efficiency is obtained from the degree of deterioration, based on the relationship as shown in FIG. 13A.

Next, the reduction rate RB of the detected NOx conversion efficiency will be explained. The longer the length of time for which the NOx selective reduction catalyst 15 is exposed to high temperatures, the greater extent to which the NOx selective reduction catalyst 15 deteriorates. In this case, the higher the temperature to which the NOx selective reduction catalyst 15 is exposed, the greater extent to which the catalyst 15 deteriorates. Accordingly, the degree of deterioration of the NOx selective reduction catalyst 15 increases with increase in the sum of the products of the catalyst temperature and the length of time for which the catalyst 15 is exposed to the temperature. Also, the NOx selective reduction catalyst 15 suffers poisoning by sulfur contained in the exhaust gas, and the degree of deterioration of the NOx selective reduction catalyst 15 increases with increase in the amount of sulfur poisoning.

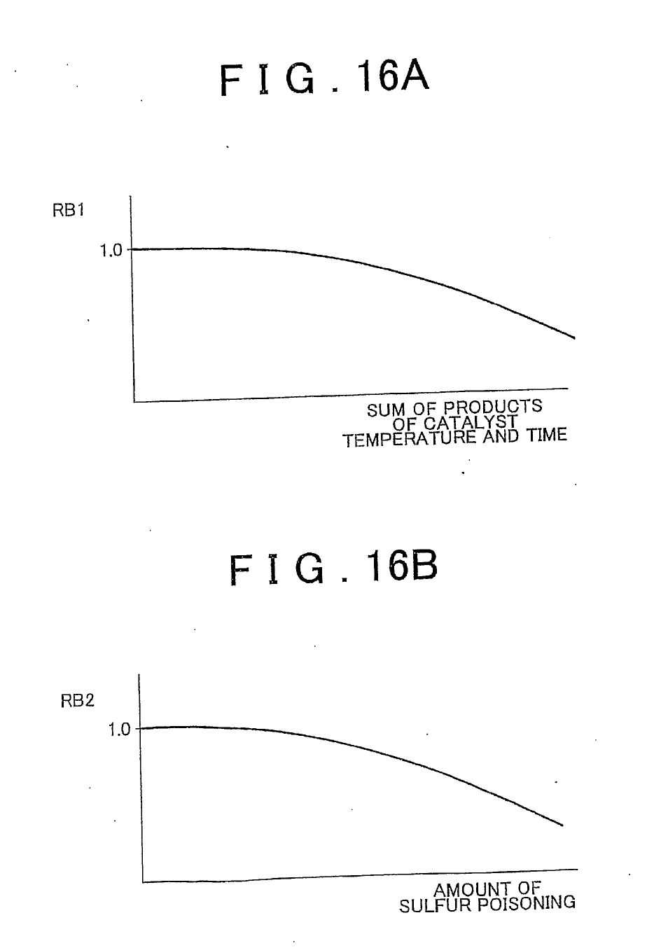

In this embodiment of the present invention, the rate of reduction RB1 of the detected NOx conversion efficiency is empirically obtained in advance as a function of the sum of the products of the catalyst temperature and the time for which the NOx selective reduction catalyst 15 is exposed to the temperature, as shown in FIG. 16A, and the rate of reduction RB2 of the detected NOx conversion efficiency is empirically obtained in advance as a function of the amount of sulfur poisoning. The reduction rate RB (=RB1×RB2) of the detected NOx conversion efficiency is obtained by calculating the product of RB1 and RB2.

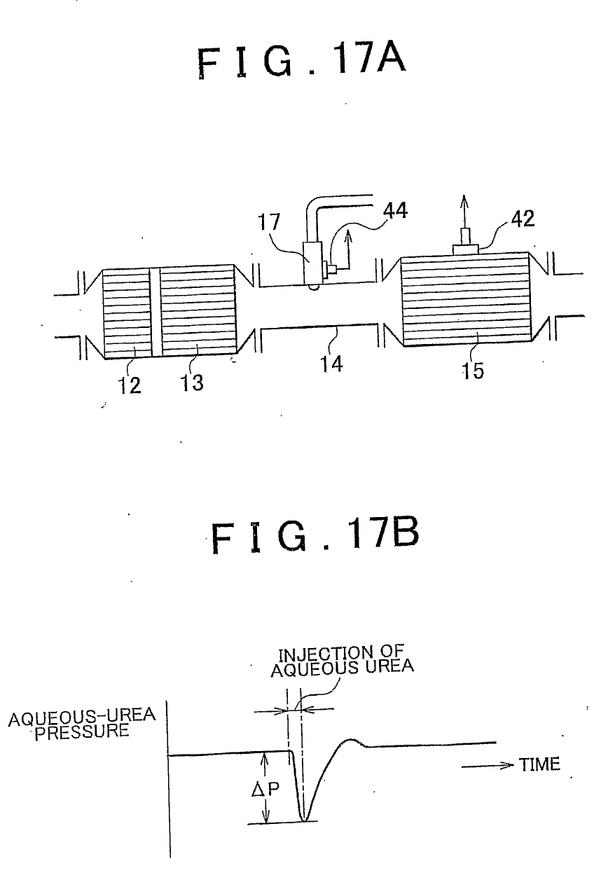

Next, the reduction rate RC of the detected NOx conversion efficiency will be explained. In a first example, a pressure sensor 44 for detecting the injection pressure at which aqueous urea is injected into the exhaust pipe 14 is mounted on the aqueous-urea supply valve 17, as shown in FIG. 17A. When aqueous urea is injected from the aqueous-urea supply valve 17, the injection pressure of aqueous urea detected by the pressure sensor 44 is temporarily reduced by AP, as shown in FIG. 17B. In this case, if the injection amount, i.e., the amount of aqueous urea injected, is reduced because of a defect, such as clogging, of the aqueous-urea supply valve 17, ΔP is reduced. Accordingly, in the first example, the degree of defectiveness of the aqueous-urea supply valve 17 is determined from the value of ΔP, and the reduction rate RC of the detected NOx conversion efficiency is obtained from the degree of defectiveness, based on the relationship as shown in FIG. 13C.

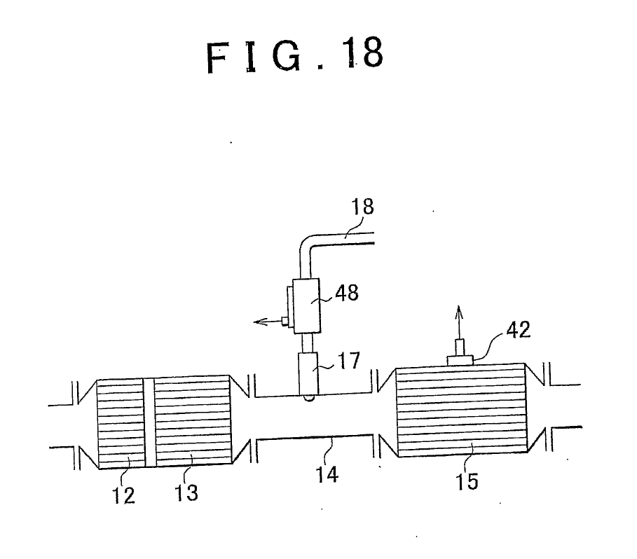

In a second example as shown in FIG. 18, a flow meter 48 for detecting the flow rate or quantity of aqueous urea supplied to the aqueous-urea supply valve 17 is disposed in the supply pipe 18. In this case, if the injection amount is reduced because of a defect, such as clogging, of the aqueous-urea supply valve 17, the flow rate of aqueous urea is reduced. Accordingly, in the second example, the degree of defectiveness of the aqueous-urea supply valve 17 is determined from the amount of reduction in the flow rate of aqueous urea, and the reduction rate RC of the detected NOx conversion efficiency is obtained from the degree of defectiveness, based on the relationship as shown in FIG. 13C.

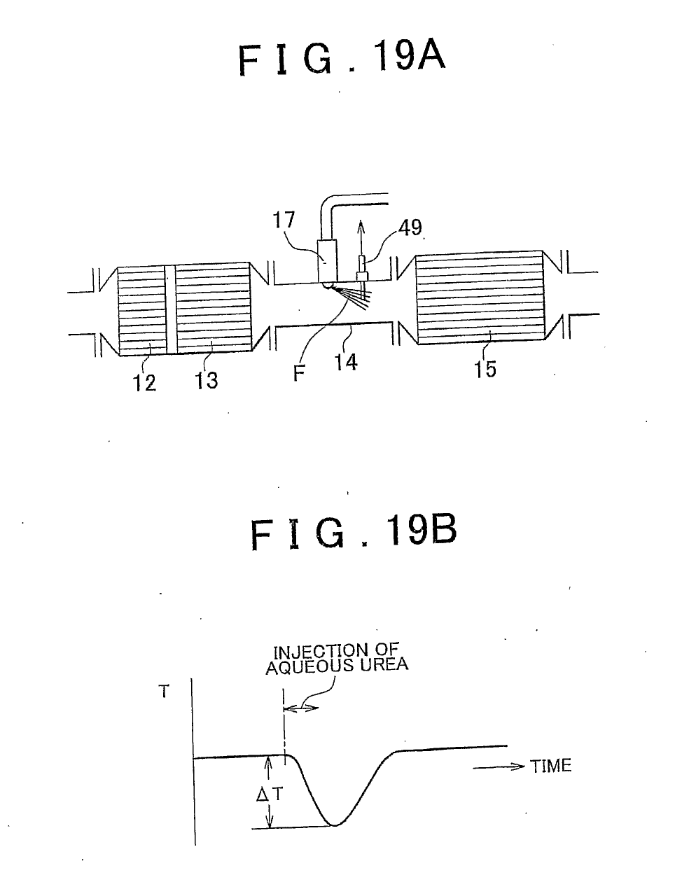

In a third example as shown in FIG. 19A, the aqueous urea solution F is injected from the aqueous-urea supply valve 17 toward a detecting portion of a temperature sensor 49. When aqueous urea is injected from the aqueous-urea supply valve 17, the temperature T of the exhaust gas detected by the temperature sensor 49 is temporarily reduced by ΔT, as shown in FIG. 19B. In this case, if the injection amount is reduced because of a defect, such as clogging, of the aqueous-urea supply valve 17, ΔT is reduced. Accordingly, in the third example, the degree of defectiveness of the aqueous-urea supply valve 7 is determined from the value of ΔT, and the reduction rate RC of the detected NOx conversion efficiency is obtained from the degree of defectiveness, based on the relationship as shown in FIG. 13C.

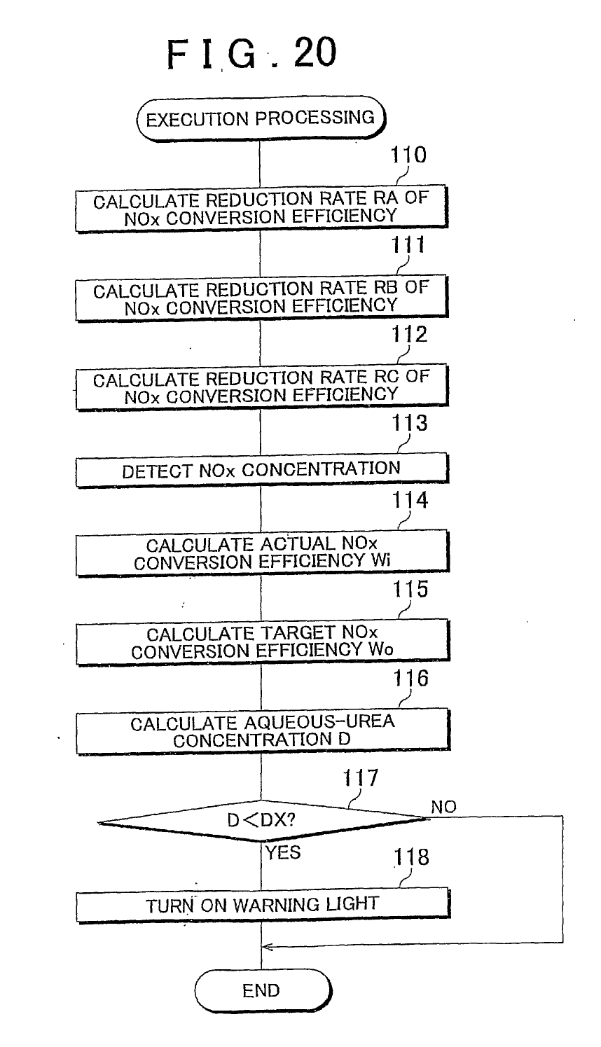

FIG. 20 illustrates an execution routine that is executed when an execution command is generated in the routine shown in FIG. 5. Referring to FIG. 20, the reduction rate RA of the detected NOx conversion efficiency is initially calculated in step 110 in any of the methods as described above, and the reduction rate RB of the detected NOx conversion efficiency is then calculated in step 111 in any of the methods as described above. Then, the reduction rate RC of the detected NOx conversion efficiency is calculated in step 112 in any of the methods as described above.

Subsequently, the NOx concentration in the exhaust gas is detected by the NOx sensor 41, and the actual NOx conversion efficiency Wi of the NOx selective reduction catalyst 15 is calculated in step 114, using the amount of NOx entering the NOx selective reduction catalyst 15, which is calculated from the map of FIG. 3, and the amount of NOx flowing out of the NOx selective reduction catalyst 15, which is calculated from the NOx concentration detected by the NOx sensor 41 and the intake air amount.

Subsequently, a target NOx conversion efficiency Wo (=Wi/(RA×RB×RC)) is calculated in step 115, by dividing the actual NOx conversion efficiency Wi by the reduction rates RA, RB, RC of the detected NOx conversion efficiency. Then, in step 116, the concentration D of aqueous urea is calculated from the NOx conversion efficiency Wo, based on the relationship as shown in FIG. 2. It is then determined in step 117 whether the concentration D of aqueous urea is lower than a predetermined threshold concentration DX. If the concentration D of aqueous urea is lower than the threshold concentration DX, the control proceeds to step 118 to turn on the warning lamp.

1. An exhaust emission control system of an internal combustion engine, wherein ammonia generated from an aqueous urea selectively reduces NOx contained in exhaust gas, comprising:
a NOx selective reduction catalyst that is disposed in an exhaust passage of the internal combustion engine;
an aqueous-urea tank that stores aqueous urea supplied to the NOx selective reduction catalyst via an aqueous-urea supply valve; and
a NOx sensor that is disposed in the exhaust passage downstream of the NOx selective reduction catalyst so as to detect a NOx conversion efficiency of the NOx selective reduction catalyst, wherein
a concentration of aqueous urea in the aqueous-urea tank is estimated from the detected NOx conversion efficiency.

2. The exhaust emission control system according to claim 1, wherein:
when the detected NOx conversion efficiency is reduced, an abnormal condition in which the concentration of aqueous urea in the aqueous-urea tank is abnormally reduced is presumed to be established.

3. The exhaust emission control system according to claim 1, wherein:
a level sensor is provided for detecting a liquid level of aqueous urea in the aqueous-urea tank, and it is determined by the level sensor whether a supplementary liquid has been supplied into the aqueous-urea tank; and
when it is determined that the supplementary liquid has been supplied into the aqueous-urea tank, and the NOx conversion efficiency detected after supply of the supplementary liquid is lower than a predetermined permissible level, the concentration of aqueous urea in the aqueous-urea tank is estimated from the detected NOx conversion efficiency.

4. The exhaust emission control system according to claim 3, wherein:
when it is determined that the supplementary liquid has been supplied into the aqueous-urea tank, and the NOx conversion efficiency detected after supply of the supplementary liquid is lower than the predetermined permissible level, an abnormal condition in which the concentration of aqueous urea in the aqueous-urea tank is abnormally reduced is presumed to be established.

5. The exhaust emission control system according to claim 1, wherein:
a level sensor is provided for detecting a liquid level of aqueous urea in the aqueous-urea tank, and it is determined by the level sensor whether a supplementary liquid has been supplied into the aqueous-urea tank;
an assumed concentration of aqueous urea in the aqueous-urea tank after supply of the supplementary liquid is calculated on the assumption that the supplementary liquid comprises a liquid having an ammonia concentration that is equal to zero; and
when it is determined that the supplementary liquid has been supplied into the aqueous-urea tank, and the NOx conversion efficiency detected after supply of the supplementary liquid is lower than a predetermined permissible level, while the assumed concentration of aqueous urea is lower than a predetermined permissible concentration, an abnormal condition in which the concentration of aqueous urea in the aqueous-urea tank is abnormally reduced is presumed to be established.

6. The exhaust emission control system according to claim 1, wherein:
a NOx conversion efficiency used for estimating the concentration of aqueous urea, which does not involve a reduction in the NOx conversion efficiency due to deterioration of the NOx sensor, is obtained from the detected NOx conversion efficiency detected by the NOx sensor, and the concentration of aqueous urea in the aqueous-urea tank is estimated from the NOx conversion efficiency used for estimating the concentration of aqueous urea.

7. The exhaust emission control system according to claim 6, wherein:
a rate of reduction of the detected NOx conversion efficiency due to deterioration of the NOx sensor is obtained, and the NOx conversion efficiency used for estimating the concentration of aqueous urea when the NOx sensor is not deteriorated is obtained from the detected NOx conversion efficiency detected by the NOx sensor and the rate of reduction of the NOx conversion efficiency.

8. The exhaust emission control system according to claim 1, wherein:
a NOx conversion efficiency used for estimating the concentration of aqueous urea, which does not involve a reduction in the NOx conversion efficiency due to deterioration of the NOx selective reduction catalyst, is obtained from the detected NOx conversion efficiency detected by the NOx sensor, and the concentration of aqueous urea in the aqueous-urea tank is estimated from the NOx conversion efficiency used for estimating the concentration of aqueous urea.

9. The exhaust emission control system according to claim 8, wherein:
a rate of reduction of the detected NOx conversion efficiency due to deterioration of the NOx selective reduction catalyst is obtained, and the NOx conversion efficiency used for estimating the concentration of aqueous urea when the NOx selective reduction catalyst is not deteriorated is obtained from the detected NOx conversion efficiency detected by the NOx sensor and the rate of reduction of the NOx conversion efficiency.

10. The exhaust emission control system according to claim 1, wherein:
a NOx conversion efficiency used for estimating the concentration of aqueous urea, which does not involve a reduction in the NOx conversion efficiency due to a defect of the aqueous-urea supply valve, is obtained from the detected NOx conversion efficiency detected by the NOx sensor, and the concentration of aqueous urea in the aqueous-urea tank is estimated from the NOx conversion efficiency used for estimating the concentration of aqueous urea.

11. The exhaust emission control system according to claim 10, wherein:
a rate of reduction of the detected NOx conversion efficiency due to the defect of the aqueous-urea supply valve is obtained, and the NOx conversion efficiency used for estimating the concentration of aqueous urea when the aqueous-urea supply valve is in normal conditions is obtained from the detected NOx conversion efficiency detected by the NOx sensor and the rate of reduction of the NOx conversion efficiency.

12. An exhaust emission control method of an internal combustion engine in which a NOx selective reduction catalyst is disposed in an exhaust passage of the internal combustion engine, and a NOx sensor is disposed in the exhaust passage downstream of the NOx selective reduction catalyst so as to detect a NOx conversion efficiency of the NOx selective reduction catalyst, wherein aqueous urea stored in an aqueous-urea tank is supplied to the NOx selective reduction catalyst via an aqueous-urea supply valve, so that ammonia generated from the aqueous urea selectively reduces NOx contained in exhaust gas, characterized by comprising:
obtaining a relationship between the NOx conversion efficiency and the concentration of the aqueous urea;
detecting the NOx conversion efficiency of the NOx selective reduction catalyst by means of the NOx sensor; and
estimating the concentration of the aqueous urea in the aqueous-urea tank from the detected NOx conversion efficiency.
